(19) United States
(12) Patent Application Publication
(10) Pub. No.: US 2010/0300020 A1
(43) Pub. Date: Dec. 2, 2010

(54) PANEL AND A METHOD OF MANUFACTURING A PANEL

(75) Inventor: Bruno Paul Louis Vermeulen, Aldeneik-Maaseik (BE)

Correspondence Address: WESTMAN CHAMPLIN & KELLY, P.A., SUITE 1400, 900 SECOND AVENUE SOUTH, MINNEAPOLIS, MN, 55402, US

(73) Assignee: Spanolux N.V.-Div.Balterio, Sint-Baafs-Vijve (BE)

(21) Appl. No.: 12/599,842

(22) PCT Filed: May 14, 2008
(86) PCT No.: PCT/EP2008/055922

§ 371 Date: May 6, 2010

(30) Foreign Application Priority Data
May 16, 2007 (EP) 07108351.3

(51) Int. Cl. E04F 15/00; B32B 37/02; B32B 5/22; B32B 29/06

(52) U.S. Cl. 52/177; 156/60; 428/207; 428/205; 428/204

(57) ABSTRACT

A panel, such as a floor panel, comprises at least a decorated side, which is provided with a pigment for creating a lustrous effect to the appearance of the decorated side. The decorated side may comprise a decoration surface and a substantially transparent protective top layer covering the decoration surface. The top layer can be provided with at least wear-resistant particles having limited or non-translucent properties, wherein the pigment is embedded in the top layer.

### CROSS-REFERENCE TO RELATED APPLICATION

The present application is a national stage filing of International patent application Serial No. PCT/EP2008/055922, filed May 14, 2008, and published as WO 2008/138952 in English.

### BACKGROUND

The discussion below is merely provided for general background information and is not intended to be used as an aid in determining the scope of the claimed subject matter.

Aspects of the invention relate to a panel, in particular a floor panel, comprising at least a decorated side.

Such a panel is well-known in the state of the art. In particular, floor panels are often provided with a decorated side imitating (natural) materials, such as a wood pattern of genuine wood planks, tiles, stones, metals (for example, Inox or aluminium, floor panels of steel, or the like).

### SUMMARY

This Summary and the Abstract herein are provided to introduce a selection of concepts in a simplified form that are further described below in the Detailed Description. This Summary and the Abstract are not intended to identify key features or essential features of the claimed subject matter, nor are they intended to be used as an aid in determining the scope of the claimed subject matter. The claimed subject matter is not limited to implementations that solve any or all disadvantages noted in the background.

An aspect of the invention includes a panel having a decorated side that is provided with a pigment for creating a lustrous effect to the appearance of the decorated side.

Due to this feature the panel obtains a lustrous or glittering appearance, such as can be observed with some natural materials, such as wood planks. In practice, the decorated side of a panel is that side which is seen when the panel is installed, for example the upper side of a flooring when this is built-up of floor panels.

In an embodiment the decorated side comprises a decoration surface and a substantially transparent protective top layer covering the decoration surface, wherein the top layer is provided with at least wear-resistant particles having limited or non-translucent properties, and the pigment is embedded in the top layer. The decoration surface may have a certain thickness and may be interpreted as a decoration layer.

Embedding the pigment in the top layer is advantageous, because if the pigment were provided below the protective top layer, the wear-resistant particles in the top layer might reduce or even eliminate the effect of the pigment. The wear-resistant particles present in the protective top layer may be aluminium oxide or corundum, for example, but a lot of alternative materials are conceivable, such as silicon carbide, titanium dioxide, quartz, sapphire, glass, and the like. This type of particles typically tends to reduce the lustrous effect of the pigment if this would be provided below the protective top layer. It is noted, that the decoration surface may be formed on a decoration layer laminated onto the panel, but a decorative pattern directly printed on an upper side of the panel is also conceivable.

The pigment may be such a material that it provides a metallic effect to the appearance of the decorated side of the panel. This may give an optical effect comparable with that of a metallic paint of a car body, panel or the like.

It is advantageous when the pigment is a non-metallic pigment, because it minimizes the risk of oxidation, thus leading to a stable optical effect of the pigment. Such a pigment is, for example, Iriodin®, commercialized by the company Merck, Colorquartz™ commercialized by the company 3M, or Crystallina, commercialized by the company Meadowbrook Inventions. Furthermore, a pigment like Xirallic® commercialized by the company Merck, which is based on synthetic aluminium oxide is conceivable. Nevertheless, the pigment may also be a metallic pigment, possibly having an anti-oxidation coating.

The top layer may comprise a paper sheet impregnated with a resin, and the pigment is disposed in the resin. The resin is, for example, a melamine-based resin. This can be implemented in an existing production method rather simple. Furthermore, it provides the opportunity to distribute the pigment evenly within the resin resulting in a uniformly distributed lustrous effect. The pigment is not necessarily distributed homogeneously within the top layer, but may have a higher or lower concentration within certain areas. It is conceivable that the wear-resistant particles are also provided in the resin, which may further improve an even distribution of both the pigment and the wear-resistant particles within the resin. In case of a non-even distribution of the pigment the distribution may be such that the pigment corresponds to a pattern of the decoration layer.

The wear-resistant particles may be disposed in pores of the paper. This is advantageous since the pigment may be disposed between the pores which are filled with the wear-resistant particles hence avoiding disturbance of the optical effect of the pigment by the particles.

Alternatively, the top layer comprises a paper sheet impregnated with a resin, and the paper sheet is provided with the pigment. In this case the pigment is not added to the resin before impregnating the paper sheet.

The wear-resistant particles can be made of, is for example corundum, quartz, sapphire, glass or the like. These materials appear to have good properties against wear.

The wear-resistant particles and/or the pigment may also be embedded in the decoration surface. In this case, the concentration of the wear-resistant particles and/or the pigment in the decoration surface may be lower than in the top layer. In practice, the decoration surface may comprise a resin impregnated decoration sheet having a certain pattern, on which sheet the wear-resistant particles and/or the pigment are arranged, or the resin contains the wear-resistant particles and/or the pigment. This may be performed in a similar way as in case of providing the top layer with the wear-resistant particles and the pigment as described hereinbefore. It is possible, for example, to print pigments on the sheet of the decoration surface and impregnate the sheet with resin that contains wear-resistant particles.

Another aspect of the invention also relates to a method of manufacturing a panel, including the steps of: providing a panel having at least one side to be decorated; applying a decoration pattern on the side; applying a protective top layer onto the side having the decoration pattern, wherein a pigment is added to the top layer.

In an advantageous way the protective top layer is prepared by providing a paper sheet and impregnating the paper sheet by a resin containing the pigment, before applying the protective top layer onto the side. This is a relatively simple method to obtain the panel such as described hereinbefore.

The resin may also contain wear-resistant particles so as to provide the opportunity to obtain an even distribution of both the pigment and the wear-resistant particles within the top layer.

Alternatively, the paper sheet may be printed with a substance containing the pigment. The substance can be an ink and the pigment can be aluminium, for example. In this case, the resin does not necessarily contain pigment.

An aspect of the invention also relates to a panel, which comprises at least a decorated side, wherein the decorated side is provided with wear-resistant particles being coated with an agent for creating a lustrous effect to the appearance of the decorated side. The advantage of this panel is that the wear-resistant particles have two effects: improving wear resistance of the decorated side as well as the esthetical appearance thereof. The lustrous effect may be a metallic effect as described hereinbefore. For example, coating of the wear-resistant particles may be performed by vapour deposition of a metal so as to create an extremely thin metallic layer. However, alternative coating processes are conceivable.

In one embodiment, the decorated side may comprise a decoration layer and a substantially transparent protective top layer covering the decoration layer, wherein the coated wear-resistant particles are embedded in at least the protective top layer. It is, however, conceivable that the particles are also embedded in the decoration layer.

The wear-resistant particles may be arranged in a certain pattern, preferably in register with a pattern of the decoration layer. This means that the lustrous effect may correspond to the pattern as arranged on the decoration layer in order to create an additional visual effect.

The wear-resistant particles may be made of corundum or glass. Corundum is a well-known material which is widely used in laminated floor panels. Glass particles also have anti-wear properties and certain particle sizes may result in anti-slip properties. In practice, the glass particles may be spherical and/or hollow, for example. Alternative materials like quartz, sapphire and the like are conceivable, as well.

Another aspect of the invention also relates to a panel, which comprises at least a decorated side, wherein the decorated side is provided with wear-resistant particles having a flat shape for creating a lustrous effect to the appearance of the decorated side. For example, a particle has a flat shape if its length and/or width is larger than its thickness. Such a shape creates a different lustrous effect than spherical particles, for example.

### BRIEF DESCRIPTION OF THE DRAWINGS

Aspects of the invention will hereafter be elucidated with reference to the drawings showing embodiments of the invention by way of example.

FIG. 1 is a very schematic cross-sectional view of an embodiment of a panel according to an aspect of the invention.

FIG. 2 is a view similar to FIG. 1 of an alternative embodiment.

FIG. 3 is a view similar to FIG. 1 of a further alternative embodiment.

### DETAILED DESCRIPTION OF THE ILLUSTRATIVE EMBODIMENTS

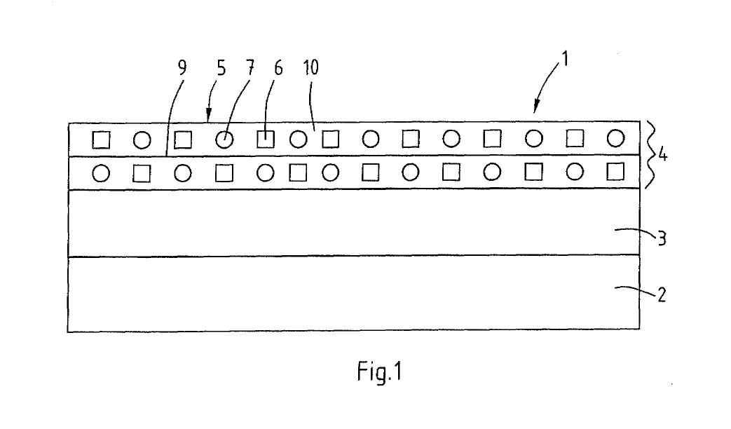

FIG. 1 shows a cross-section of an embodiment of a panel 1 according to an aspect of the invention, in this case a floor panel 1. The panel 1 comprises a core 2, a decoration layer 3 and a protective top layer or overlay 4. The core 2 may comprise one or more layers of MDF, HDF, HTSP, PVC, composites or the like, and possibly a balancing layer. It is noted that the core 2 and the layers 3, 4 such as shown in FIG. 1 have different scales in practice. The layers 3, 4 will generally be much thinner than the core 2. The decoration layer 3 is provided with a surface decoration which imitates natural materials, such as wood.

The decoration layer 3 includes a laminate of paper layers impregnated with a resin. It is also possible that a decoration pattern is directly applied onto the core 2, such that the decoration layer 3 is formed by a coating or paint or the like. In any case an upper surface of the decoration layer 3 forms a decoration surface of the panel.

The embodiment of FIG. 1 has an upper surface 5, which is seen as the decorated side of the panel 1 by an observer. The protective top layer 4 covers the decoration layer 3 and is substantially transparent. This means that the decoration layer 3 can be seen through the protective top layer 4. The protective top layer 4 is provided with wear-resistant particles 6, such as illustrated by squares in FIG. 1. These particles 6 may be made of aluminium oxide or corundum or the like, and have limited or non-translucent properties. Nevertheless, the particles 6 have such a size and are distributed within the protective top layer 4 such that the decoration layer 3 can still be observed through the protective top layer 4.

In the embodiment of the panel 1 a pigment 7 is embedded in the top layer 4. The pigment is illustrated by circles in FIG. 1. The pigment 7 creates a lustrous effect to the appearance of the upper side 5 of the panel 1. It may imitate a metallic-like glittering effect of real wood planks, stone or metal, for example. It is advantageous when the pigment 7 is a non-metallic pigment, since it minimizes the risk of oxidation thereof. Alternatively, the pigment may be a metal, possibly coated with an anti-oxidation layer. In the embodiment shown in FIG. 1 the top layer 4 comprises a paper sheet 9 which is impregnated with a resin 10. The pigment 7 as well as the wear-resistant particles 6 are embedded in the resin. In practice, after impregnating the paper sheet 9 with resin 10 it is laminated onto the decoration layer 3 of the panel 1 by means of elevated pressure and temperature. It is also possible that the paper sheet 9 is printed with an ink, for example, which ink contains a pigment, for example aluminium or an alternative material.

It appears that the lustrous effect due to the pigment 7 in the top layer 4 is improved with respect to the condition in which the pigment is disposed below the top layer 4 since the wear-resistant particles 6 may disturb the lustrous effect of the pigment 7 in this case.

In an alternative embodiment the wear-resistant particles are disposed in pores of the paper sheet 9 (not shown). In this case the pigment 7 is added to the resin 10 and impregnated to the paper 9 which contains the particles 7.

In still another alternative embodiment the top layer 4 may comprise a paper sheet 9 impregnated with a resin 10, wherein the paper sheet 9 is provided with the pigment 7 (not shown). In this case the wear-resistant particles 6 can be added to the resin 10 with which the paper sheet 9 is subsequently impregnated.

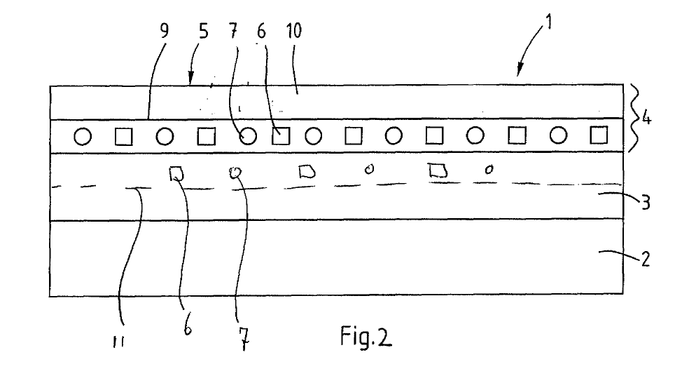

FIG. 2 shows an alternative embodiment of a panel 1 in which the decoration layer 3 is also provided with the wear-resistant particles 6 and the pigment 7. In this embodiment the wear-resistant particles 6 and the pigment 7 are applied on a lower side of the paper sheet 9 of the top layer 4, and on an upper side of a paper sheet 11 having a decoration pattern within the decoration layer 3. However, several alternatives of this embodiment are conceivable. The concentration of the wear-resistant particles 6 and the pigment 7 in the top layer 4 may be different from that in the decoration layer 3. Furthermore, the pigment 7 may be printed on the paper sheet 11, whereas the wear-resistant particles are provided in a resin which is impregnated in the paper sheet 11, for example. As stated above, the embodiment of FIG. 2 shows, that the paper sheet 9 in the top layer 4 is provided with wear-resistant particles 6 at the side thereof facing the decoration layer 3. Due to this configuration wear of pressing tools for laminating the panel 1 is minimized.

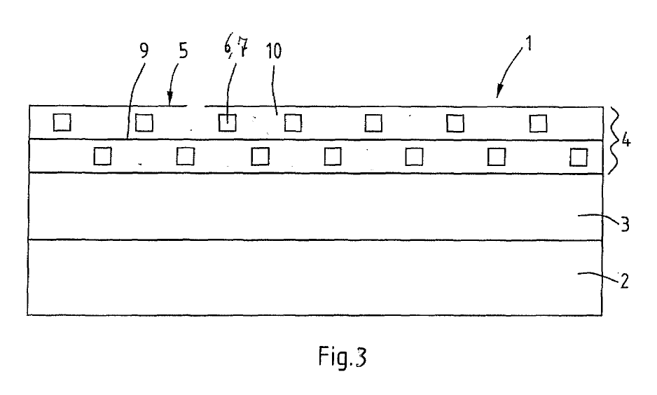

In a further alternative embodiment the decorated side 5 is provided with wear-resistant particles 6, 7, which are coated with an agent for creating a lustrous effect to the appearance of the decorated side 5, see FIG. 3. The wear-resistant particles 6, 7 are made of corundum or glass and the coating may comprise a certain color in order to obtain a lustrous or metallic effect. In fact, in this embodiment the pigment 7 and the wear-resistant particles 6 are integrated in coated wear-resistant particles 6, 7, such as shown in FIG. 3. The decorated side 5 comprises a decoration layer 3 and a substantially transparent protective top layer 4 which covers the decoration layer 3. In the embodiment as shown in FIG. 3 the coated wear-resistant particles 6, 7 are embedded in the resin of the protective top layer 4. The particles 6, 7 may also be contained in the paper sheet 9, for example, and additionally in the decoration layer 3.

From the foregoing it may be clear that the panel according to the invention provides a decorated side having a lustrous effect, hence imitating natural materials better.

Aspects of the invention are not limited to the embodiment shown in the drawing and the embodiments described hereinbefore, which may be varied in different manners within the scope of the claims and their technical equivalents. It is, for example, possible to provide the pigment below the top layer, in particular in case of applying wear-resistant particles which have good translucent properties or in case of no or a low density of wear-resistant particles. Furthermore, a paper sheet may be omitted in the top layer; a top layer formed by a coating containing wear-resistant particles and pigment is conceivable.

At least a part of the decoration layer may also be provided on the top layer or overlay. Besides, the top layer may be embossed, possibly in register with a pattern on the decoration layer.

1. A panel, comprising at least a decorated side, wherein the decorated side is provided with a pigment for creating a lustrous effect to the appearance of the decorated side.

2. The panel according to claim 1, wherein the decorated side comprises a decoration surface and a substantially transparent protective top layer covering the decoration surface, said top layer being provided with at least wear-resistant particles having limited or non-translucent properties, wherein the pigment is embedded in the top layer.

3. The panel according to claim 1, wherein the pigment is such a material that it provides a metallic effect to the appearance of the decorated side of the panel.

4. The panel according to claim 1, wherein the pigment is a non-metallic pigment.

5. The panel according to claim 2, wherein the pigment is such a material that it provides a metallic effect to the appearance of the decorated side of the panel, and wherein the top layer comprises a paper sheet impregnated with a resin, and the pigment is disposed in the resin.

6. The panel according to claim 5, wherein the wear-resistant particles are disposed in pores of the paper.

7. The panel according to claim 2, wherein the top layer comprises a paper sheet impregnated with a resin, and the paper sheet is provided with the pigment.

8. The panel according to claim 2, wherein the wear-resistant particles are made of corundum.

9. The panel according to claim 2, wherein the wear-resistant particles and/or the pigment is/are embedded in the decoration surface.

10. A method of manufacturing a panel, comprising:
providing a panel having at least one side to be decorated,
applying a decoration pattern on the side,
applying a protective top layer onto the side having the decoration pattern, wherein a pigment is added to the top layer.

11. The method according to claim 10, wherein before applying the protective top layer onto the side the protective top layer is prepared by providing a paper sheet and impregnating the paper sheet by a resin containing the pigment.

12. The method according to claim 11, wherein the resin also contains wear-resistant particles.

13. The method according to claim 11, wherein the paper sheet is printed with a substance containing the pigment.

14. A panel, comprising at least a decorated side, wherein the decorated side is provided with wear-resistant particles being coated with an agent for creating a lustrous effect to the appearance of the decorated side.

15. The panel according to claim 14, wherein the decorated side comprises a decoration layer and a substantially transparent protective top layer covering the decoration layer, wherein the wear-resistant particles are embedded in at least the protective top layer.

16. The panel according to claim 15, wherein the wear-resistant particles are arranged in a certain pattern.

17. The panel according to claim 14, wherein the wear-resistant particles are made of corundum or glass.

18. A panel, comprising at least a decorated side, wherein the decorated side is provided with wear-resistant particles having a flat shape for creating a lustrous effect to the appearance of the decorated side.
